(19) United States
(12) Patent Application Publication
(10) Pub. No.: US 2014/0104024 A1
(43) Pub. Date: Apr. 17, 2014

(54) ALLOY, MAGNET CORE AND METHOD FOR PRODUCING A STRIP FROM AN ALLOY

(71) Applicant: Vacuumschmelze GmbH & Co. KG, Hanau (DE)

(72) Inventors: Giselher HERZER, Bruchkobel (DE); Mie Marsilius, Klein-Auheim (DE); Christian Polak, Blankenbach (DE)

(73) Assignee: Vacuumschmelze GmbH & Co. KG, Hanau (DE)

(21) Appl. No.: 14/052,368

(22) Filed: Oct. 11, 2013

(30) Foreign Application Priority Data
Oct. 12, 2012 (DE) 10 2012 109 744.5

(51) Int. Cl. H01F 1/047; H01F 41/02

(52) U.S. Cl. CPC H01F 1/047; H01F 41/02
USPC 335/297; 148/304; 148/121

(57) ABSTRACT

An alloy of Fe_{100-a-b-c-d-x-y-z}CuₐNb_{b}M_{c}T_{d}SiₓB_{y}Z_{z} and up to 1 atomic % impurities; M is one or more of Mo or Ta, T is one or more of V, Cr, Co or Ni and Z is one or more of C, P or Ge, wherein 0.0 atomic % a <1.5 atomic %, 0.0 atomic % b <3.0 atomic %, 0.2 atomic % c 4.0 atomic %, 0.0 atomic % d <5.0 atomic %, 12.0 atomic %<x<18.0 atomic %, 5.0 atomic %<y<12.0 atomic % and 0.0 atomic % z<2.0 atomic %, and wherein 2.0 atomic % (b+c) 4.0 atomic %, produced in the form of a strip and having a nanocrystalline structure in which at least 50% by volume of the grains have an average size of less than 100 nm, a remanence ratio Jᵣ/Jₛ<0.02, Jᵣ being the remanent polarisation and Jₛ being the saturation polarisation, and a coercitive field strength H_{c} which is less than 1% of the anisotropic field strength Hₐ and/or less than 10 A/m.

This application claims benefit under 35 U.S.C. §119 of the filing date of DE 10 2012 109 744.5, filed Oct. 12, 2012, the entire contents of which are incorporated by reference herein for all purposes.

### BACKGROUND

1. Field

Disclosed herein is an alloy, in particular a soft magnetic alloy, which is suitable for use as a magnet core, to a magnet core and to a method for producing a strip from an alloy.

2. Description of Related Art

Nanocrystalline alloys based on a composition consisting of Fe_{100-a-b-c-d-x-y-z}CuₐNb_{b}M_{c}T_{d}SiₓB_{y}Z_{z} can be used as magnet cores in various applications. U.S. Pat. No. 7,583,173 discloses a wound magnet core which is used, among other applications, in a current transformer consisting of (Fe₁₋ₐNiₐ)_{100-x-y-z-a-b-c}CuₓSi_{y}B_{z}Nb_{α}M′_{β}M″_{γ}, wherein a≦0.3, 0.6≦x≦1.5, 10≦y≦17, 5≦z≦14, 2≦α≦6, β≦7, γ≦8, M′ is one or more of the elements V, Cr, Al and Zn and M″ is one or more of the elements C, Ge, P, Ga, Sb, In and Be.

EP 0 271 657 A2 likewise discloses alloys with a composition on this basis.

In applications for magnet cores, low production costs are generally desirable. Any reduction in costs, however, should have little, if any consequences for the magnetic properties of the magnet core.

### SUMMARY

There remains a need, therefore, to provide an alloy which has magnetic properties suitable for use as magnet cores and which can be produced cost-effectively.

This problem is solved by one or more of the embodiments disclosed herein.

Disclosed herein is an alloy consisting of Fe_{100-a-b-c-d-x-y-z}CuₐNb_{b}M_{c}T_{d}SiₓB_{y}Z_{z} and up to 1 atomic % impurities. M is one or more of the elements Mo or Ta, T is one or more of the elements V, Cr, Co or Ni and Z is one or more of the elements C, P or Ge, wherein 0.0 atomic %≦a≦1.5 atomic %, 0.0 atomic %≦b<3.0 atomic %, 0.2 atomic %≦c≦4.0 atomic %, 0.0 atomic %≦d<5.0 atomic %, 12.0 atomic %<x<18.0 atomic %, 5.0 atomic %<y<12.0 atomic % and 0.0 atomic %≦z<2.0 atomic %. The sum of the elements Nb, Mo and Ta (b+c) is 2.0 atomic % (b+c) 4.0 atomic %. The alloy is provided in the form of a strip and has a nanocrystalline structure, at least 50% by volume of the grains having an average size of less than 100 nm. The alloy further has a remanence ratio Jᵣ/Jₛ<0.02, Jᵣ being the remanent polarisation and Jₛ being the saturation polarisation, and a coercitive field strength H_{c} which is less than 1% of the anisotropic field strength Hₐ and/or less than 10 A/m.

The alloy thus has a composition with a niobium content of less than 3 atomic % as well as Mo and/or Ta, the total content of Nb and/or Mo and/or Ta lying between 2 atomic % and 4 atomic %. This composition offers the advantage that raw material costs are lower than when using a composition with a higher niobium content, for niobium is a relatively expensive element. Furthermore, owing to the Mo and/or Ta content, the coercitive field strength is kept relatively low.

An increased coercitive field strength results in higher hysteresis losses, which have a negative effect on remagnetisation losses in the low-frequency range.

As a result, the low coercitive field strength combined with low raw materials costs as made available by the alloy according to the invention is advantageous in low-frequency applications.

The lower limit of the silicon content and the upper limit of the boron content of the alloy are specified such that the alloy can be produced in form of a strip using tension in a continuous furnace, whereby the magnetic properties mentioned above are obtained. This being so, the alloy can, using this production method, be produced with the desired magnetic properties for magnet core applications despite its low niobium content.

The form of a strip not only allows the alloy to be produced under tension in a continuous furnace, but also the production of a magnet core with any number of windings. As a result, the size and the magnetic properties of the magnet core can easily be adapted to a specific application by choosing suitable windings. The nanocrystalline structure with a grain size of less than 100 nm in at least 50 percent by volume of the alloy results in a low saturation magnetostriction at a high saturation polarisation. With a suitable alloy selection, the heat treatment under tension results in a remanence ratio of less than 0.02 and a coercitive field strength H_{c} which amounts to less than 1% of the anisotropic field strength Hₐ and/or less than 10 A/m, preferably less than 5 A/m.

In further embodiments, the alloy has a magnetic hysteresis loop with a central linear section. The central section of the hysteresis loop is defined as the section of the hysteresis loop which lies between the anisotropic field strength points which indicate the transition into saturation.

A linear section of this central part of the hysteresis loop is herein described using a non-linearity factor NL, which is calculated as follows:

$$N L = \frac{100}{2} ( δ {J}_{auf} + δ {J}_{ab} ) / {J}_{s}$$

wherein δJ_{auf} is the standard deviation of the magnetic polarisation from a regression line through the ascending branch of the hysteresis loop between polarisation values of ±75% of the saturation polarisation Jₛ and δJ_{ab} is the standard deviation of the magnetic polarisation from a regression line through the descending branch of the hysteresis loop between polarisation values of ±75% of the saturation polarisation Jₛ.

In one embodiment, the alloy has a hysteresis loop with a non-linearity factor NL, wherein NL<0.5%.

This alloy is therefore particularly suitable for a magnet core having a reduced size and a lower weight and, while involving low raw material costs, nevertheless having the desired soft magnetic properties for use as a magnet core.

In one embodiment, the remanence ratio of the alloy is less than 0.01. The hysteresis loop of the alloy is therefore even more linear or even flatter.

In one embodiment, the alloy further has a permeability μ between 200 and 4000 or an anisotropic field strength Hₐ in the range between 250 A/m and 4000 A/m. The permeability or the anisotropic field strength can primarily be determined by choosing an appropriate tension in the heat treatment process, the anisotropic field strength being proportional to the applied tension and the permeability being inversely proportional to the applied tension. In this embodiment, the tension lies in a range between approximately 10 MPa (μ˜4000, Hₐ˜250 A/m) and approximately 250 MPa (μ˜200, Hₐ˜5000 A/m). In one embodiment, the coercitive field strength has a value of less than 8 A/m even at these high anisotropic field strengths.

The limits mentioned for permeability and anisotropic field strength are indicated by way of example and should not be understood as restrictive. By reducing the tension to approximately 5 MPa, maximum permeabilities (minimum anisotropic field strengths) up to μ˜10000 (Hₐ˜100 A/m) can be set, while minimum permeabilities (maximum anisotropic field strengths) up to μ˜50 (Hₐ˜20000 A/m) can be set by increasing the tension.

The lower the permeability, the higher currents can flow through the windings of the magnetic core without saturating the material. Furthermore, at the same permeability values these currents can be the higher the higher the saturation polarisation Jₛ of the material is. On the other hand, the inductance of the magnet core increases with its permeability and size. In order to build magnet cores combining a high inductance with a high current tolerance, it is therefore advantageous to use alloys having a higher saturation polarisation. In one embodiment, the saturation polarisation Jₛ=1.22 T at a coercitive field strength of less than 8 A/m, preferably less than 5 A/m. This can eventually be used without reducing the size and the weight of the core.

The alloy can have a saturation magnetostriction of less than 1 ppm. Alloys with a saturation magnetostriction below these limit values have particularly good magnetic properties even at internal tension. For higher permeability values, it is advantageous to select alloys with lower saturation magnetostriction values.

In one embodiment, the alloy does not contain any niobium, i.e. b=0. This embodiment offers the advantage that raw material costs are reduced further, because the niobium element has been omitted completely.

In a further embodiment, the alloy does not contain any copper, i.e. a=0. In another embodiment, the alloy does not contain any niobium or copper, i.e. a=0 and b=0.

In a further embodiment, the alloy contains both niobium and copper, wherein 0 atomic %<a≦0.5 atomic % and 0 atomic %<b≦0.5 atomic %.

In one embodiment, 0<b≦2 and 2 atomic %≦(b+c)≦4 atomic %, so that, in addition to niobium, the alloy contains molybdenum and/or tantalum as well.

In a further embodiment, the alloy does not contain any molybdenum and the minimum tantalum content is 0.2 atomic %, and the minimum niobium content is 1.8 atomic %. In one embodiment, the alloy does not contain any niobium or molybdenum, having a tantalum content between 2 atomic % and 4 atomic %.

In a further embodiment, the alloy does not contain any tantalum, and the minimum molybdenum content is 0.2 atomic % and the minimum niobium content is 1.8 atomic %, or the minimum molybdenum content is 0.7 atomic % and the minimum niobium content is 1.3 atomic %, or the minimum molybdenum content is 1.0 atomic % and the minimum niobium content is 1.0 atomic %. In one embodiment, the alloy does not contain any niobium or tantalum, having a molybdenum content between 2 atomic % and 4 atomic %.

In a further embodiment, the alloy does not contain any niobium and comprises a combination of molybdenum and tantalum. In a further embodiment, the alloy contains niobium, molybdenum and tantalum.

The total niobium, molybdenum and tantalum content (b+c) is 2 atomic %≦(b+c)≦4 atomic %. In further embodiments, the total niobium, molybdenum and tantalum content is 2.0 atomic %≦(b +c)<4.0 atomic % or 2.1 atomic %≦(b+c)≦3.0 atomic %.

In one embodiment, the upper limit of the content of the elements V, Cr, Co and/or Ni is restricted to 0.0 atomic %≦d<2.0 atomic %.

In one embodiment, the silicon content and the boron content are defined more closely, being 14.0 atomic %<x<17.0 atomic % and 5.5 atomic %<y<8.0 atomic % respectively.

As mentioned above, the alloy is produced in the form of a strip. This strip can generally have a thickness of 10 μm to 50 μm. Both with very thin strip and with very thick strip, there is an increased risk of tearing. The surface roughness can in strips of a thickness of less than approximately 17-19 μm result in holes, where the strip can easily tear when subjected to tension in the heat treatment process. At strip thickness values above 24-25 μm, the parent material may have local brittle areas where the strip tears. For this reason, the alloys referred to should preferably be given a strip thickness in the range of 18-22 μm. A particularly suitable strip should not have any holes and should be as smooth as possible, i.e. if possible have an average roughness Rₐ of less than 1 μm. The strip width can be between 0.5 mm and 100 mm. The probability of tearing during the heat treatment process, due to a notch effect, is however greatly reduced as the strip becomes narrower. This being so, strip widths of less than 30 mm, or even better less than 15 mm, should preferably be used. For the illustrated embodiments, strips with a width of 6 mm and 10 mm were chosen. The average strip thickness was approximately 18-22 μm. In this context, it should be noted that the width and the thickness of the strip are, during the heat treatment process under tension, reduced in proportion to the tension applied. The width and the thickness of the strip are relatively reduced by 2-3% each per 100 MPa tension applied.

In a further embodiment, at least 70 percent by volume of the grains have an average size of less than 50 nm. This makes a further improvement of the magnetic properties possible.

The alloy, in the form of a strip, is heat-treated under tension in order to obtain the desired magnetic properties. The alloy, i.e. the finished heat-treated strip, is therefore characterised by a structure which has been produced by this production method. In one embodiment, the crystallites have an average size of approximately 20-25 nm and a residual elongation between approximately 0.02% and 0.5%, which is proportional to the tension applied in the heat treatment process. A heat treatment under a tension of 100 MPa, for example, results in an elongation of approximately 0.1%.

The magnetic properties of the alloy are influenced by the heat treatment parameters. In one embodiment, the strip is heat-treated in a continuous process at an annealing temperature between 450° C. and 750° C. under a tension of 10 MPa to 250 MPa with a dwell time of 2 seconds to 2 minutes. These temperatures, tensions and dwell times make it possible to obtain the desired magnetic properties for the alloy with a niobium content of less than 2 atomic %, a molybdenum and/or tantalum content of 0.2 atomic % to 4 atomic % and a total content of Nb, Mo and Ta of 2.0 atomic % to 4.0 atomic %.

A magnet core made from an alloy according to any of the above embodiments is also provided. The magnet core can have the form of a wound strip, and to form the magnet core, the strip can be wound in one plane or as a solenoid about a longitudinal axis, depending on application.

The strip of the magnet core can additionally be coated with an insulating layer to isolate the windings of the magnet core electrically from one another. This layer can for example be a polymer layer or a ceramic layer. The strip can be coated with the insulating layer before and/or after being wound into a magnet core. This insulating layer is optional, however.

In further embodiments, the strip has a natural insulating layer. As soon as in the production process of the strip, but also in the heat treatment process, a thin oxide layer, for example of silicon oxides, having a thickness of a few atomic layers can form, which provides enough insulation of the strip layers for many applications.

The magnet core according to one of the above embodiments can be used in various components. A power transformer, a current transformer and a storage choke with a magnet core according to any of these embodiments are also provided.

A method for producing a strip is also provided, the method comprising the following steps: A strip is provided from an amorphous alloy having a composition consisting of Fe_{100-a-b-c-d-x-y-z}CuₐNb_{b}M_{c}T_{d}SiₓB_{y}Z_{z} and up to one atomic % impurities, wherein M is one or more of the elements Mo or Ta, T is one or more of the elements V, Cr, Co or Ni and Z is one or more of the elements C, P or Ge, and wherein 0.0 atomic %≦a<1.5 atomic %, 0.0 atomic %≦b<3.0 atomic %, 0.2 atomic %≦c≦4.0 atomic %, 0.0 atomic %≦d<5.0 atomic %, 12.0 atomic %<x<18.0 atomic %, 5.0 atomic %<y<12.0 atomic % and 0.0 atomic %≦z<2.0 atomic % and 2 atomic %≦(b+c)≦4 atomic %. The strip is heat-treated under tension at a temperature of 450° C. to 750° C. to produce suitable magnetic properties for use as a magnet core.

The heat treatment results in the formation of a nanocrystalline structure with at least 50% by volume of the grains having an average size of less than 100 nm. Using this method, the composition can in particular be produced with a niobium content of less than 3 atomic % or less than 2 atomic % as well as 0.2 atomic % to 4 atomic % molybdenum and/or tantalum in such a way that it has a remanence ratio Jᵣ/Jₛ<0.02, Jᵣ being the remanent polarisation and Jₛ being the saturation polarisation, and a coercitive field strength H_{c} which is less than 1% of the anisotropic field strength Hₐ and/or less than 10 A/m.

The strip is heat-treated in a continuous process, for example in a continuous furnace. The strip is pulled through the continuous furnace at a speed s. This speed s can be adjusted such that a dwell time of the strip in a temperature zone of the continuous furnace which has a temperature within 5% of the temperature T lies between 2 seconds and 2 minutes. The time required for heating the strip to the temperature T is comparable to the duration of the heat treatment itself. The same applies to the duration of the following cooling process. In this annealing temperature range, this dwell time results in the desired structure and the desired magnetic properties.

In one embodiment, the strip is pulled through the continuous furnace under a tension between 5 MPa and 1000 MPa. This tension range is suitable for producing the desired magnetic properties in the above compositions.

In further embodiments, the strip is heat-treated in the continuous furnace under a tension of 10 MPa to 250 MPa or under a tension of 250 MPa to 1000 MPa.

This tension range determines the permeability range. Tensions between 5 MPa and 1000 MPa give permeability values between 40 and 10000. Tensions of 10 MPa to 250 MPa give permeability values in the range of 200 to 4000. Tensions above 250 to approximately 1000 MPa can also be used, resulting in flat loops with permeability values in the range of approximately μ˜50 to ˜200, which are particularly desirable for storage chokes.

The desired magnetic properties can also be dependent on the annealing temperature T and can therefore be adjusted by selecting the annealing temperature. In one embodiment, the temperature T is selected as a function of the niobium content in accordance with the relation (Tₓ₁+50° C.) T (Tₓ₂+30° C.). In this relation, Tₓ₁ and Tₓ₂ are the crystallisation temperatures defined by the maximum of the transition heat, which are determined using thermal standard methods, such as DSC (differential scanning calorimetry) at a heating rate of 10 K/min.

In a further embodiment, a desired value of the anisotropic field strength Hₐ or the permeability and/or a maximum value of a remanence ratio Jᵣ/Jₛ of less than 0.02 and/or a maximum values of a coercitive field strength H_{c} which is less than 1% of the anisotropic field strength Hₐ and/or less than 10 A/m, as well as a permitted deviation range for each of these values, are predetermined.

To achieve this (these) value(s) along the length of the strip, the magnetic properties of the strip are continuously measured as it leaves the continuous furnace. If deviations outside the permitted range of magnetic properties are detected, the tension applied to the strip is adjusted accordingly in order to bring the measured values of the magnetic properties within the permitted deviation range.

This embodiment reduces the deviations of the magnetic properties along the length of the strip, so that the magnetic properties within a magnet core are more homogeneous and/or the magnetic properties of several magnet cores made from a single strip deviate less from one another. In this way, the uniformity of the soft magnetic properties of the magnet cores can be improved, in particular in commercial production.

### BRIEF DESCRIPTION OF DRAWINGS

Embodiments will now be explained in greater detail with reference to the following examples, tables and drawings.

FIG. 1 shows the hysteresis loops of an alloy according to the invention which is heat-treated under two different tensions,

FIG. 2 shows magnetic properties for alloys according to the invention with various Nb and Mo contents, produced at different annealing temperatures,

FIG. 3 shows magnetic properties for alloys produced at different tensions, and

FIG. 4 is a diagrammatic view of a continuous furnace.

Table 1 lists the magnetic properties for various alloys according to the invention and for comparative examples,

Table 2 shows further alloy examples and their magnetic properties, and

Table 3 lists crystallisation temperatures Tₓ₁ and Tₓ₂ (DSC 10 K/min, peak) and annealing temperatures T for three alloys from Table 1.

### DETAILED DESCRIPTION OF SPECIFIC EMBODIMENTS

Various alloys based on Fe_{100-a-b-c-d-x-y-z}CuₐNb_{b}M_{c}T_{d}SiₓB_{y}Z_{z} are produced in the form of an amorphous strip. Typical strips have a width of 6 mm to 10 mm and a thickness of 17 μm to 25 μm. The amorphous strip can for example be produced in the desired composition by means of a rapid solidification technology. These amorphous strips are then heat-treated to produce a nanocrystalline structure and the desired magnetic properties.

In alloys based on Fe_{100-a-b-c-d-x-y-z}CuₐNb_{b}M_{c}T_{d}SiₓB_{y}Z_{z}, the reduction of the Nb content is desirable in order to reduce raw material costs without at the same time increasing the coercitive field strength too much. Below, it is disclosed that this can be achieved by wholly or partially replacing Nb by Mo or Ta, wherein the total content of the elements from the Nb and/or Mo and/or Ta group(s) is at least 2 atomic % and the niobium content is less than 3 atomic % or less than 2 atomic %.

Table 1 shows the saturation polarisation Jₛ as measured in the production state and the values for saturation magnetostriction λs, nonlinearity NL, remanence ratio Jᵣ/Jₛ, coercitive field strength H_{c}, anisotropic field strength Hₐ and relative permeability μ as measured after heat treatment under a tension of 50±10 MPa for various alloy compositions. Composition data are given in atomic percent.

The heat treatment was performed under a tension of 50±10 MPa for a duration of 4 seconds in the case of comparative examples (a) and (i) and for a duration of 6 seconds in the case of comparative examples (ii) and (iii) and in the case of examples 1 to 10 according to the invention at the annealing temperatures T given in the table. Examples 1 to 10 in Table 1 all have a reduced Nb content of less than 2 atomic %.

In the alloy examples 1, 2 and 3, Nb is completely replaced by various Mo contents. For Mo contents from 2 atomic %, the coercitive field strength is less than 8 A/m, decreasing further with increasing Mo contents.

In the alloy examples 4 and 5, Nb is completely replaced by various Ta contents. For Ta contents around 2 atomic %, the coercitive field strength, being H_{c}=3 A/m, is comparable to the comparative examples, but magnetic saturation polarisation Jₛ is higher.

One advantage of Ta and Mo over Nb is their better availability on the world market. Ta has the advantage of being more effective in reducing coercitive field strength, in particular compared to Mo. The high raw material costs of Ta are a disadvantage, however. In view of this, attempts were made to replace Nb only partially, if possible with Mo.

In alloy example 6, the major part of Nb was replaced by Mo and Ta. Here, too, coercitive field strength values are comparable to the comparative examples, combined with a higher magnetic saturation polarisation Jₛ.

In the alloy examples 7 to 10, Nb is partially replaced by Mo. Here, too, coercitive field strength values are markedly less than 10 A/m, if the total content of Nb and Mo is at least 1.9 atomic %. If the composition approaches the lower limit, it is advantageous if the Nb content is slightly higher than the Mo content.

Table 2 shows further alloy examples 11 and 12 and their magnetic properties after a heat treatment of 6 s under a tension of 50±10 MPa at the annealing temperature given in the table.

The magnetic properties demonstrate that the addition of Mo and Ta is possible if the Nb content is higher than 2 atomic %. Alloy example 11, for instance, indicates that even a minor addition of 0.2 atomic % Mo combined with a reduction of the Nb content by 0.3 atomic % results in a slight H_{c} reduction compared to comparative example (a) from Table 1, the saturation polarisation Jₛ being advantageously increased by about 15%. In alloy example 12, Nb is substituted by Ta, resulting in magnetic properties comparable to those of example (a) from Table 1, if the alloy is heat-treated using a suitable tension at a suitable annealing temperature.

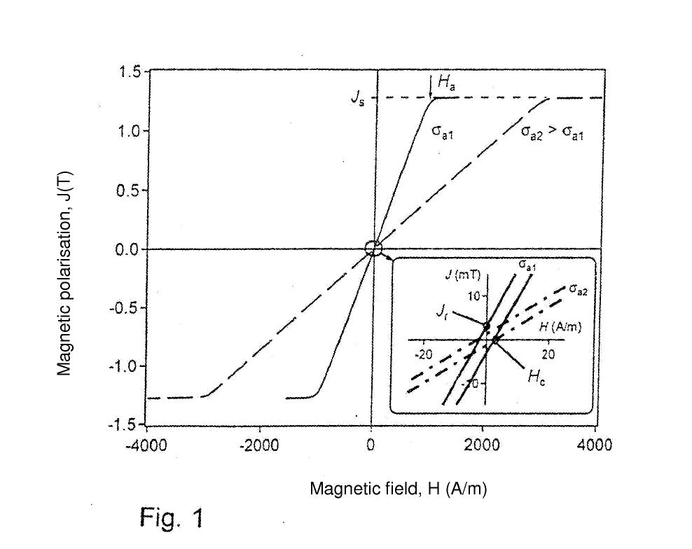

Further embodiments are disclosed in FIGS. 1, 2 and 3.

FIG. 1 shows a typical hysteresis loop which results from heat treatment under tension. FIG. 1 shows the quasi-static hysteresis loop of the alloy Fe_{74.7}Cu_{0.8}Nb_{1.4}Mo₁Si_{15.5}B_{6.6} after a heat treatment of 6 s at 650° C. with two different tensions, wherein σₐ₁˜50 MPa and σₐ₂˜140 MPa.

FIG. 1 further illustrates the definition of the magnetic saturation polarisation Jₛ, of the anisotropic field strength Hₐ, of the coercitive field strength H_{c} and of the remanent polarisation Jᵣ. For an alloy according to the invention, the coercitive field strength should, at an anisotropic field strength Hₐ of approximately 1000 A/m, be less than 10 A/m, i.e. less than approximately 1% of Hₐ. Such low values are difficult to measure at full modulation of the hysteresis loop (measuring accuracy approximately ±1/Am) and therefore hardly identifiable with the bare eye in FIG. 1. Nevertheless, if remagnetisation losses are to be minimised, it is advisable to keep to such low values.

A characteristic of the hysteresis loop is its linearity in the centre of the hysteresis loop. A measure for this is a low remanence ratio Jᵣ/Jₛ.

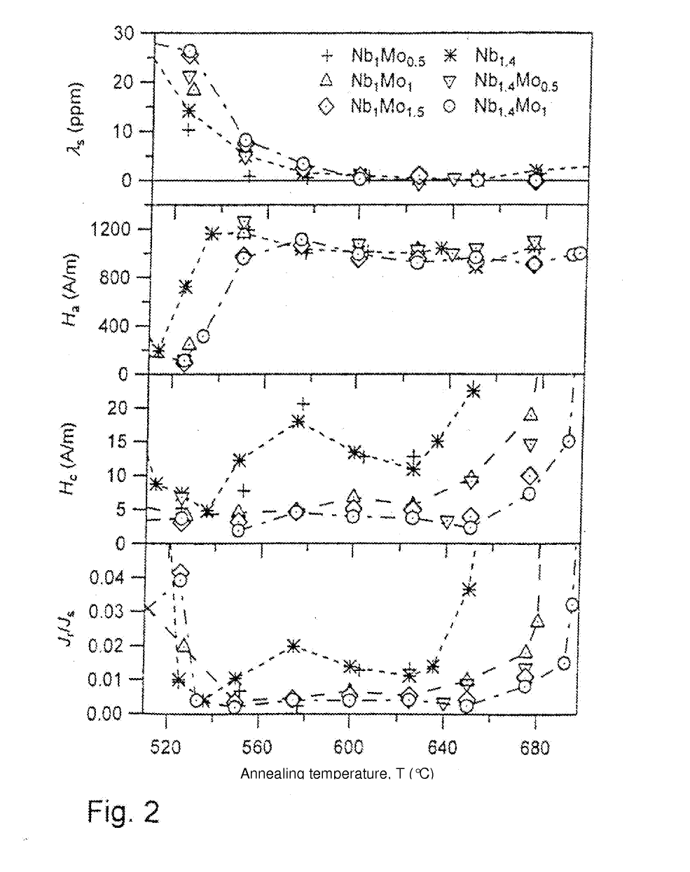

FIG. 2 shows the saturation magnetostriction λs, the anisotropic field strength Hₐ, the coercitive field strength H_{c} and the remanence ratio Jᵣ/Jₐ as a function of the annealing temperature T for Fe_{77.1-x-y}Cu_{0.8}NbₓMo_{y}Si_{15.5}B_{6.6} with two different Nb contents and increasing Mo contents after a heat treatment of approximately 6 seconds under a tension of approximately 50 MPa. The compositions involved are Fe_{75.6}Cu_{0.8}Nb₁Mo_{0.5}Si_{15.5}B_{6.6}, Fe_{75.1}Cu_{0.8}Nb₁Mo₁Si_{15.5}B_{6.6}, Fe_{74.6}Cu_{0.8}Nb₁Mo_{1.5}Si_{15.5}B_{6.6}, Fe_{75.7}Cu_{0.8}Nb_{1.4}Si_{15.5}B_{6.6}, Fe_{75.2}Cu_{0.8}Nb_{1.4}Mo_{0.5}Si_{15.5}B_{6.6} and Fe_{74.7}Cu_{0.8}Nb_{1.4}Mo₁Si_{15.5}B_{6.6}.

The desired magnetic properties, i.e. a low saturation magnetostriction λs, a defined anisotropic field strength Hₐ, a low coercitive field strength H_{c} and a low remanence ratio Jᵣ/Jₛ, are obtained in a specific annealing window which is characteristic for the respective alloy and which is characterised by a minimum annealing temperature T₁ and a maximum annealing temperature T₂. This annealing range can be determined by a standard measurement of the crystallisation temperatures Tₓ₁ and Tₓ₂, for example by means of DSC (differential scanning calorimetry), allowing the annealing temperature T to be defined.

Table 3 shows crystallisation temperatures Tₓ₁ and Tₓ₂ (DSC 10 K/min, peak) and suitable annealing temperatures T for the alloy Fe_{75.5-x}Cu_{0.8}Nb_{1.4}MoₓSi_{15.5}B_{6.6} for annealing times of approximately 6 seconds. The example number corresponds to the alloy composition given in Table 1. Table 3 shows by way of example the context for the annealing time of approximately 6 seconds used here.

The results from FIG. 2 make clear that the saturation magnetostriction and the anisotropic field strength behave approximately in the same way in all examples, while there are noticeable differences in coercitive field strength and remanence ratio.

Complementing Table 1, FIG. 2 discloses that alloys with a total (Nb+Mo) content from approximately 2 atomic % (which includes 1.9 atomic %) have in a wide annealing temperature range a coercitive field strength significantly lower than 10 A/m. Alloys with a total (Nb+Mo) content >2.3 atomic % exhibit with H_{c}=5 A/m even better values within a large range, which furthermore react less sensitively to the precise annealing temperature. Compared to this, alloys with an (Nb+Mo) content typically have a coercitive field strength between 10 and 20 A/m and correspondingly high hysteresis losses. In addition, H_{c} changes relatively markedly with the annealing temperature.

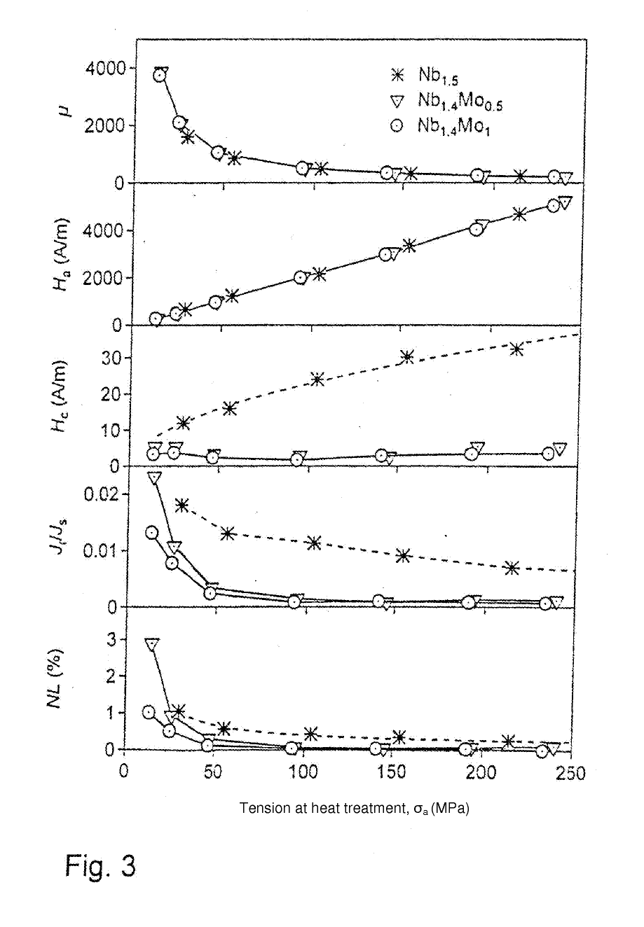

The above examples relate to a annealing tension σₐ of approximately 50 MPa. FIG. 3 shows the effect of this annealing tension on magnetic values.

FIG. 3 shows the relative permeability the anisotropic field strength Hₐ, the coercitive field strength H_{c}, the remanence ratio Jᵣ/Jₐ and the nonlinearity factor of the alloys Fe_{75.7-y}Cu_{0.8}Nb_{1.4}Mo_{y}Si_{15.5}B_{6.6} with y=0.5 atomic % and y=1 atomic % after a heat treatment of 6 seconds at 640° C. for Mo=0.5 atomic % or at 650° C. for Mo=1 atomic % compared to Fe_{75.5}Cu₁Nb₁Si_{15.5}B_{6.5} at a heat treatment of 4 seconds at 610° C. as a function of the tension σₐ applied during the heat treatment.

FIG. 3 discloses that the anisotropic field strength Hₐ increases proportionally with the tension applied during the heat treatment, while the permeability is reduced inversely proportionally to σₐ. The annealing tension σₐ is finally selected such that a predefined value for permeability and anisotropic field strength is set. In this respect, all of the alloy examples shown behave in a similar way, while there are noticeable differences in coercitive field strength, i.e. in hysteresis losses. The alloys according to the invention exhibit even better coercitive field strength values at increased annealing tensions. For example, while in an alloy with 1.5 atomic % Nb the coercitive field strength increases noticeably with the tension applied, an Mo addition of only 0.5 atomic % reduces the tension-dependence of H_{c}, thereby effecting an improvement. This applies correspondingly to an addition of 1 atomic %, which has even better effects. This also applies to lower annealing tensions, which are used if a lower anisotropic field strength and permeability values equal to or higher than 2000 are to be set.

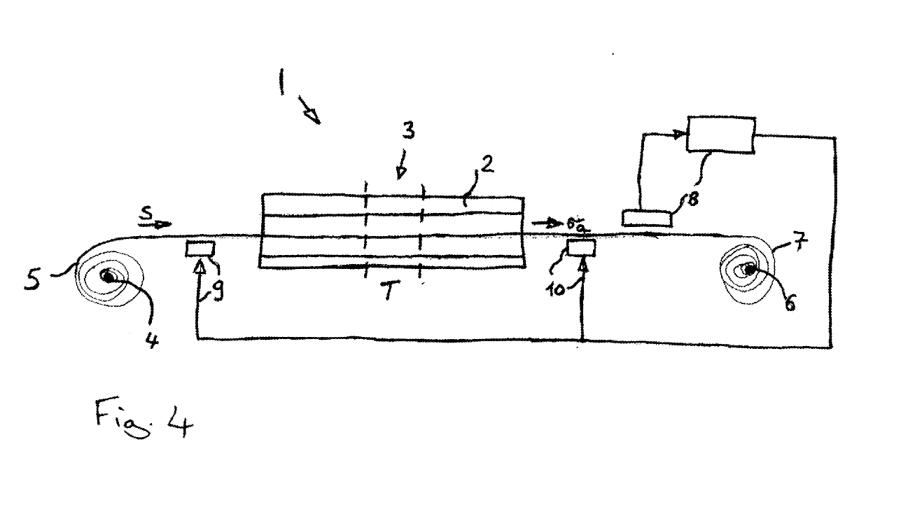

FIG. 4 is a diagrammatic view of an apparatus 1 suitable for producing the alloys with a composition according to any of the above embodiments in the form of a strip. The apparatus 1 comprises a continuous furnace 2 with a temperature zone 3 which is adjusted such that the temperature in the furnace within this zone is within 5° C. of the annealing temperature T. The apparatus 1 further comprises a reel 4 on which the amorphous alloy 5 is wound and a take-up reel 6 which receives the heat-treated strip 7. The strip 7 is pulled by the reel 4 through the continuous furnace 2 to the take-up reel 6 with a speed s. In this process, the strip is subjected to a tension σₐ in the running direction from the device 9 to the device 10.

The apparatus 1 further comprises a device 8 for continuously measuring the magnetic properties of the strip 6 after it has been heat-treated and pulled out of the continuous furnace 2. In the region of this device 8, the strip 7 is no longer subjected to tension. The measured magnetic properties can be used for adjusting the tension σₐ under which the strip 7 is pulled through the continuous furnace 2. This is indicated diagrammatically in FIG. 13 by arrows 9 and 10. By this measuring of the magnetic properties and the continuous tension adjustment, the uniformity of the magnetic properties along the length of the strip can be improved.

TABLE 1

| | Composition | Jₛ | Tₐ | λₛ | NL | | H_{c} | Hₐ | |
|---|---|---|---|---|---|---|---|---|---|
| No. | (atomic %) | (T) | (° C.) | (ppm) | (%) | Jᵣ/Jₛ | (A/m) | (A/m) | μ |
| (a) | Fe₇₄Cu₁Nb₃Si_{15.5}B_{6.5} | 1.21 | 690 | 0.1 | 0.3 | 0.004 | 3 | 850 | 1130 |
| (i) | Fe_{75.5}Cu₁Nb_{1.5}Si_{15.5}B_{6.5} | 1.34 | 635 | 0.6 | 0.6 | 0.008 | 13 | 1180 | 890 |
| (ii) | Fe_{75.7}Cu_{0.8}Nb_{1.4}Si_{15.5}B_{6.6} | 1.36 | 625 | 0.4 | 0.7 | 0.011 | 11 | 1000 | 1085 |
| (iii) | Fe_{75.6}Cu_{0.8}Nb₁Mo_{0.5}Si_{15.5}B_{6.6} | 1.37 | 625 | −0.5 | 0.7 | 0.013 | 13 | 1000 | 1085 |
| 1 | Fe_{75.1}Cu_{0.8}Mo₂Si_{15.5}B_{6.6} | 1.30 | 625 | 0.5 | 0.2 | 0.010 | 7 | 1170 | 880 |
| 2 | Fe_{74.1}Cu_{0.8}Mo₃Si_{15.5}B_{6.6} | 1.23 | 655 | −0.06 | 0.5 | 0.006 | 6 | 1000 | 980 |
| 3 | Fe_{73.1}Cu_{0.8}Mo₄Si_{15.5}B_{6.6} | 1.14 | 640 | 0.2 | 0.07 | 0.003 | 3 | 1020 | 945 |
| 4 | Fe_{75.1}Cu_{0.8}Ta₂Si_{15.5}B_{6.6} | 1.31 | 640 | 0.3 | 0.10 | 0.003 | 3 | 1080 | 885 |
| 5 | Fe_{74.1}Cu_{0.8}Ta₃Si_{15.5}B_{6.6} | 1.23 | 640 | 0.4 | 0.07 | 0.002 | 2 | 1010 | 950 |
| 6 | Fe_{74.1}Cu_{0.8}Nb₁Mo₁Ta₁Si_{15.5}B_{6.6} | 1.24 | 640 | 0.2 | 0.09 | 0.004 | 4 | 990 | 965 |
| 7 | Fe_{74.6}Cu_{0.8}Nb₁Mo_{1.5}Si_{15.5}B_{6.6} | 1.27 | 650 | 0.4 | 0.3 | 0.004 | 4 | 930 | 1095 |
| 8 | Fe_{74.7}Cu_{0.8}Nb_{1.4}Mo₁Si_{15.5}B_{6.6} | 1.28 | 650 | −0.06 | 0.1 | 0.002 | 2 | 960 | 1060 |
| 9 | Fe_{75.2}Cu_{0.8}Nb_{1.4}Mo_{0.5}Si_{15.5}B_{6.6} | 1.32 | 640 | 0.4 | 0.3 | 0.003 | 3 | 1000 | 1040 |
| 10 | Fe_{75.1}Cu_{0.8}Nb₁Mo₁Si_{15.5}B_{6.6} | 1.31 | 625 | 0.6 | 0.3 | 0.005 | 6 | 1025 | 1020 |

(a) comparative example
(i), (ii), (iii) comparative example
(1)-(10) examples according to the invention

TABLE 2

| | Composition | Jₛ | Tₐ | λₛ | NL | | H_{c} | Hₐ | |
|---|---|---|---|---|---|---|---|---|---|
| No. | (atomic %) | (T) | (° C.) | (ppm) | (%) | Jᵣ/Jₛ | (A/m) | (A/m) | μ |
| 11 | Fe_{74.2}Cu_{0.8}Nb_{2.7}Mo_{0.2}Si_{15.5}B_{6.6} | 1.24 | 640 | 0.7 | 0.1 | 0.002 | 2 | 930 | 1025 |
| 12 | Fe_{74.0}Cu_{0.8}Nb_{2.2}Ta_{0.9}Si_{15.5}B_{6.6} | 1.22 | 675 | −0.1 | 0.1 | 0.003 | 4 | 970 | 980 |

TABLE 3

| No. | Mo (atomic %) | Tₓ₁ (° C.) | Tₓ₁ (° C.) | Annealing temperature T |
|---|---|---|---|---|
| (ii) | 0 | 488 | 645 | 540° C. to 630° C. |
| 9 | 0.5 | 498 | 662 | 550° C. to 650° C. |
| 8 | 1.0 | 505 | 678 | 550° C. to 670° C. |

1. An alloy having a composition consisting of
Fe_{100-a-b-c-d-x-y-z}CuₐNb_{b}M_{c}T_{d}SiₓB_{y}Z_{z} and up to 1 atomic % impurities, wherein M is Mo and/or Ta, T is one or more of the elements V, Cr, Co or Ni and Z is one or more of the elements C, P or Ge, and wherein 0.0 atomic %≦a<1.5 atomic %, 0.0 atomic %≦b<3.0 atomic %, 0.2 atomic %≦c≦4.0 atomic %, 0.0 atomic %≦d<5.0 atomic %, 12.0 atomic %<x<18.0 atomic %, 5.0 atomic %<y<12.0 atomic %, 0.0 atomic %≦z<2.0 atomic % and 2.0 atomic %≦(b+c)≦4.0 atomic %,
wherein the alloy is in the form of a strip,
wherein the alloy comprises a nanocrystalline structure, at least 50% by volume of the grains having an average size of less than 100 nm,
wherein the alloy has a remanence ratio Jᵣ/Jₛ<0.02, Jᵣ being the remanent polarisation and Jₛ being the saturation polarisation, and
wherein the alloy has a coercitive field strength H_{c} which is less than 1% of the anisotropic field strength Hₐ and/or less than 10 A/m.

2. The alloy according to claim 1, wherein the remanence ratio Jᵣ/Jₛ is <0.01.

3. The alloy according to claim 1, wherein the hysteresis loop of the alloy has a nonlinearity factor NL, NL being <0.5%, and
$$N L = \frac{100}{2} ( δ {J}_{auf} + δ {J}_{ab} ) / {J}_{s}$$
wherein δJ_{auf} is the standard deviation of the magnetic polarisation from a regression line through the ascending branch of the hysteresis loop between polarisation values of ±75% of the saturation polarisation Jₛ and δJ_{ab} is the standard deviation of the magnetic polarisation from a regression line through the descending branch of the hysteresis loop between polarisation values of ±75% of the saturation polarisation Jₛ.

4. The alloy according to claim 1, wherein the alloy has a permeability μ between 40 and 10000.

5. The alloy according to claim 1, wherein the alloy has a saturation magnetostriction of less than 1 ppm.

6. The alloy according to claim 1, wherein the alloy has a saturation polarisation Jₛ that is ≧1.22 T and the coercitive field strength H_{c} is ≦8 A/m.

7. The alloy according to claim 1, wherein 0.0 atomic %≦b<2.5 atomic % or 0.0 atomic %≦b<2.0 atomic %.

8. The alloy according to claim 1, wherein 2.1 atomic %≦(b+c)≦3.0 atomic %.

9. The alloy according to claim 1, wherein 0.0 atomic %≦d<2.0 atomic %.

10. The alloy according to claim 1, wherein 14.0 atomic %<x<17 atomic % and 5.5 atomic %<y<8.0 atomic %.

11. The alloy according to claim 1, wherein the strip is heat-treated in a continuous process at a annealing temperature between 450° C. and 750° C. under a tension of 5 MPa to 1000 MPa with a dwell time of 2 seconds to 2 minutes.

12. The alloy according to claim 11, wherein the strip is heat-treated in a continuous process under a tension of 10 MPa to 250 MPa with a dwell time of 2 seconds to 2 minutes.

13. The alloy according to claim 11, wherein the strip is heat-treated in a continuous process under a tension of 250 MPa to 1000 MPa with a dwell time of 2 seconds to 2 minutes.

14. A magnet core made from an alloy according to claim 1.

15. The magnet core according to claim 14, having the form of a wound strip.

16. The magnet core according to claim 14, wherein the strip has an oxide layer with a thickness of <0.2 μm on its surface.

17. The magnet core according to claim 14, wherein the strip is coated with an additional insulating layer.

18. A method for producing a strip, comprising the following:
providing a strip from an amorphous alloy with a composition consisting of Fe_{100a-b-c-d-x-y-z}CuₐNb_{b}M_{c}T_{d}SiₓB_{y}Z_{z} and up to 1 atomic % impurities, wherein M is Mo and/or Ta, T is one or more of the elements V, Cr, Co or Ni and Z is one or more of the elements C, P or Ge, and wherein 0.0 atomic %≦a<1.5 atomic %, 0.0 atomic %≦b<3.0 atomic %, 0.2 atomic %≦c≦4.0 atomic %, 0.0 atomic %≦d<5.0 atomic %, 12.0 atomic %<x<18.0 atomic %, 5.0 atomic %<y<12.0 atomic %, 0.0 atomic %≦z<2.0 atomic % and 2.0 atomic %≦(b+c)≦4.0 atomic %, and
heat treating the strip under tension in a continuous process at a temperature Tₐ, wherein 450° C.≦Tₐ≦750° C.

19. The method according to claim 18, wherein the strip is heat-treated in a continuous furnace.

20. The method according to claim 19, wherein the strip is pulled through the continuous furnace with a speed s, so that a dwell time of the strip in a temperature zone of the continuous furnace at the temperature Tₐ is between 2 seconds and 2 minutes.

21. The method according to claim 18, wherein the strip is heat-treated in the continuous furnace under a tension of 5 MPa to 1000 MPa.

22. The method according to claim 21, wherein the strip is heat-treated in the continuous furnace under a tension of 10 MPa to 250 MPa.

23. The method according to claim 21, wherein the strip is heat-treated in the continuous furnace under a tension of 250 MPa to 1000 MPa.

24. The method according to claim 18, further comprising:
predetermining a desired value of the anisotropic field strength Hₐ or the permeability and/or a maximum value of a remanence ratio Jᵣ/Jₛ of less than 0.02 and/or a maximum value of a coercitive field strength H_{c} which is less than 1% of the anisotropic field strength Hₐ and/or less than 10 A/m, as well as a permitted deviation range for each of these values, and
measuring magnetic properties of the strip continuously as it leaves the continuous furnace, and
if deviations from the permitted deviation range of the magnetic properties are detected, adjusting the tension applied to the strip accordingly, in order to bring the measured values of the magnetic properties back within the permitted deviation range.
